(19) United States
(12) Patent Application Publication
(10) Pub. No.: US 2007/0204158 A1
(43) Pub. Date: Aug. 30, 2007

(54) Methods and apparatus for encryption key management

(75) Inventors: Jason Hatashita, San Jose, CA (US); Puneet Batta, Santa Clara, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/363,608

(22) Filed: Feb. 28, 2006

(51) Int. Cl. H04L 9/00

(52) U.S. Cl. 713/171; 370/352

(57) ABSTRACT

A wireless switch is configured to send encrypted data over a network by performing the steps of: receiving a packet having a destination within a virtual local area network (VLAN) having an associated VLAN number, the VLAN being mapped within a wireless local area network (WLAN) having an associated service set identification (SSID); generating a key, wherein the key is derived from a broadcast key for the SSID, the VLAN number, and a mixer-key; encrypting the packet with the key to produce an encrypted packet; and sending said encrypted packet to said destination.

### TECHNICAL FIELD

The present invention relates generally to wireless local area networks (WLANs) and, more particularly, to encryption key management in WLANs implementing multiple virtual local area networks (VLANs).

### BACKGROUND

In recent years, there has been a dramatic increase in demand for mobile connectivity solutions utilizing various wireless components and wireless local area networks (WLANs). Such WLANs often implement numerous virtual LANs (VLANs), which provide a logical separation between stations within a particular WLAN.

To ensure that inter-VLAN boundaries are maintained for broadcast traffic, the access point (AP) will typically encrypt frames using a different key for every VLAN that it dynamically maps. Doing so becomes onerous quickly, however, as it requires that the AP maintain one broadcast key per VLAN, for every SSID that the AP supports.

In practical wireless switching architectures, this results in one encryption key per WLAN, per VLAN, per access point. In a switch with 32 WLANs, 32 VLANs, and 48 APs, for example, about 20 MB of keying information needs to be maintained. This is an undesirably large amount of information.

Accordingly, it is desirable to provide systems that are capable of efficient and scalable key generation and management in the context of VLAN networks. Furthermore, other desirable features and characteristics of the present invention will become apparent from the subsequent detailed description and the appended claims, taken in conjunction with the accompanying drawings and the foregoing technical field and background.

### BRIEF SUMMARY

In accordance with the present invention, a method for sending encrypted data over a network includes: receiving a packet having a destination within a virtual local area network (VLAN) having an associated VLAN number, the VLAN being mapped within a wireless local area network (WLAN) having an associated service set identification (SSID); generating a key, wherein the key is derived from a broadcast key for the SSID, the VLAN number, and a mixer-key; encrypting the packet with the key to produce an encrypted packet; and sending said encrypted packet to said destination. A new key may be generated whenever traffic is sent to the specific target VLAN. Thus, keys are only generated as they are needed, and only one broadcast key is needed per SSID. The key may be generated using a simple mathematical operation applied to two or more of these values, or may be generated using a cryptographic function—e.g., AES, MD5, SHA1, or the like.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a wireless network useful in describing the present invention;

FIG. 2 is a flowchart depicting a method in accordance with one embodiment of the present invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

Without loss of generality, in the illustrated embodiment, many of the functions usually provided by a traditional access point (e.g., network management, wireless configuration, and the like) are concentrated in a corresponding wireless switch. It will be appreciated that the present invention is not so limited, and that the methods and systems described herein may be used in the context of other network architectures.

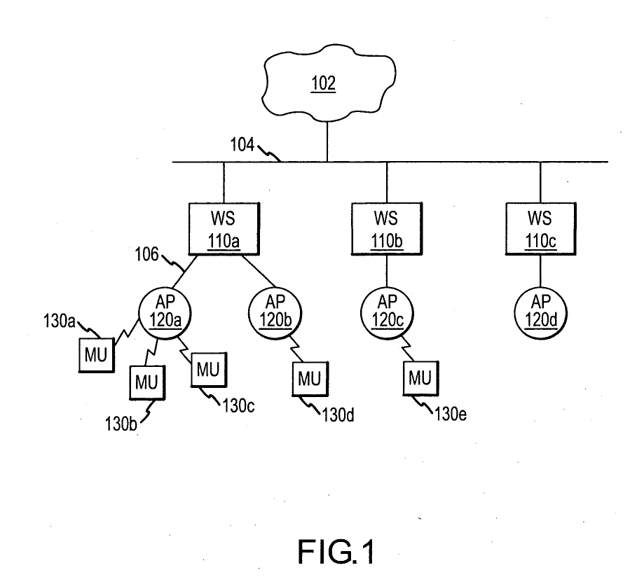

Referring to FIG. 1, one or more switching devices 110 (alternatively referred to as “wireless switches,” “WS,” or simply “switches”) are coupled to a network 104 (e.g., an Ethernet network coupled to one or more other networks or devices, indicated by network cloud 102). One or more wireless access ports 120 (alternatively referred to as “access ports” or “APs”) are configured to wirelessly connect to one or more mobile units 130 (or “MUs”). APs 120 are suitably connected to corresponding switches 110 via communication lines 106 (e.g., conventional Ethernet lines). Any number of additional and/or intervening switches, routers, servers and other network components may also be present in the system.

A particular AP 120 may have a number of associated MUs (or “stations”) 130. For example, in the illustrated topology, MUs 130(a), 130(b), and 130(c) are associated with AP 120(a), while MU 130(e) is associated with AP 120(c). Furthermore, one or more APs 120 may be connected to a single switch 110. Thus, as illustrated, AP 120(a) and AP 120(b) are connected to WS 110(a), and AP 120(c) is connected to WS 110(b).

Each WS 110 determines the destination of packets it receives over network 104 and routes that packet to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110.

AP 120 is typically capable of communicating with one or more MUs 130 through multiple RF channels. This distribution of channels varies greatly by device, as well as country of operation. For example, in one U.S. embodiment (in accordance with 802.11(b)) there are fourteen overlapping, staggered channels, each centered 5 MHz apart in the RF band.

A basic service set (BSS) is a set of stations (e.g., MUs 130 and APs 120) controlled by a single coordination function. An extended service set (ESS) is a set of one or more interconnected BSSs and integrated LANs that appear as a single BSS to the logical link control layer at any station association with one of those BSSs. Each BSS has an ID (BSSID), e.g., the MAC address of the corresponding AP 120. The AP 120 generates any management and/or control frames (e.g., beacons and the like) using this BSSID as the source. The service set ID (SSID) is the name of the network (i.e., the WLAN), and in one embodiment is a name of up to 32 characters in length.

A VLAN subdivides a physical WLAN into multiple virtual networks. Each VLAN is typically identified by a unique number (a VLANID) which is transmitted in every packet associated with that VLAN. Thus, MU 130(b) and MU 130(c) may be within one VLAN, and MU 130(a) may be within another. Additional information regarding such VLANs may be found, for example, in IEEE standard document 802.1Q.

Having thus given an overview of an example WLAN useful in describing the present invention, an exemplary method will now be described. In this regard, the various tasks performed in connection with the illustrated process may be performed by software, hardware, firmware, or any combination thereof. It should be appreciated that the process may include any number of additional or alternative tasks, need not be performed in the illustrated order, and may be incorporated into a more comprehensive procedure or process having additional functionality not described in detail herein.

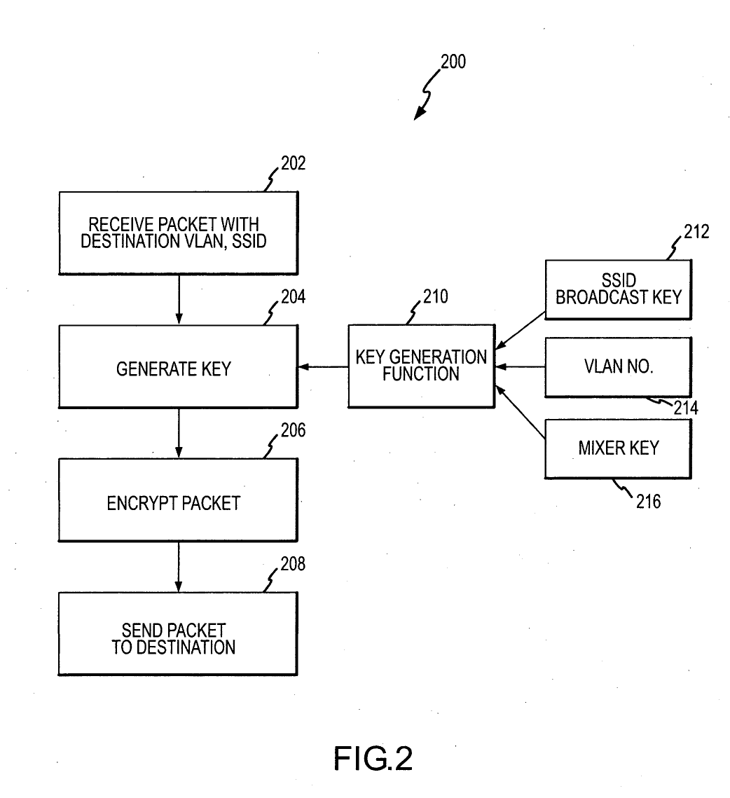

Referring to FIG. 2, a packet is first received by the switch or other device having a key generation module provided therein (step 202). The packet has a destination station within an WLAN having an associated SSID. The destination station also has a corresponding VLAN (mapped within the WLAN), and the VLAN has an associated VLAN number (or “VLANID”).

In step 204, a key is generated by applying a key generation function 210 to two or more values—e.g., the SSID broadcast key 212 (e.g., the original or “base” broadcast key), the VLAN number 214, and a mixer key 216. The key generation function 210 may involve simply a mathematical operation (i.e., summation, multiplication, etc.) applied to two or more of the values. Alternatively, a cryptographic function is used for key generation function 210, e.g., MD5, SHA1, or AES. Such cryptographic functions are known in the art, and need not be described further herein. For additional information regarding cryptographic functions, see, e.g., Bruce Schneier, Applied Cryptography(1994).

Key generation function 210 may be performed by a key generation module provided within a wireless switch 110 and/or any other suitable component. The key generation module may be implemented in software, hardware, firmware, or any combination thereof.

The SSID broadcast key comprises any suitable alphanumerical code. As is known in the art, the SSID is a token that identifies a particular 802.11 network. In one embodiment, in accordance with the 802.11 family of standards, the SSID broadcast key comprises a 1-32 character code that is broadcast to other entities that which to join the network. This broadcast key may be “rotated,” as provided by 802.11, where the key is changed at regular intervals by performing an operation on the previous key.

The VLAN number comprises any suitable numeric value. In one embodiment, the VLAN number corresponds to a VLANID as specified in IEEE 802.11Q—i.e., an unsigned 16-bit integer.

The mixer key comprises any suitable number or string of alphanumeric characters. In one embodiment, the mixer key is randomly generated whenever the corresponding SSID is initialized. In another embodiment, the mixer key is regenerated whenever broadcast keys are rotated, as described above. In a further embodiment, the mixer key is regenerated whenever the last MU within a VLAN leaves that VLAN. The mixer key may also be a NULL value—i.e., the mixer key may be an optional parameter. The key may be of any particular length, depending upon implementation. In one embodiment, for example, a 128-bit key is used.

After the key is generated, the packet is encrypted (step 206) using the key previously generated in step 204. This step may be performed by an encryption module that is part of a wireless switch 110, and may be implemented in software, hardware, firmware, or a combination thereof. Finally, in step 208, the encrypted packet is then sent to the destination station, where it is suitable decrypted. Decryption takes place by an entity (e.g., an MU 130) that has access to the keys used during step 206.

Thus, in accordance with above, keys are only generated as they are needed, and only one broadcast key is needed per SSID. This requires a relatively small amount of information to be stored, and improves scalability of the system.

It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method of sending encrypted data over a network, said method comprising:
receiving a packet having a destination within a virtual local area network (VLAN) having an associated VLAN number, said VLAN being mapped within a wireless local area network (WLAN) having an associated service set identification (SSID);
generating a key, wherein said key is derived by applying a key generation function on a broadcast key for said SSID, said VLAN number, and a mixer-key.
encrypting said packet with said key to produce an encrypted packet;
sending said encrypted packet to said destination.

2. The method of claim 1, further including generating said mixer key randomly when said SSID is initialized.

3. The method of claim 2, further including rotating a plurality of said broadcast keys and regenerating said mixer key during said rotating step.

4. The method of claim 2, wherein said mixer key is regenerated when a mobile unit within said VLAN leaves said VLAN.

5. The method of claim 2, wherein said mixer key is a null value.

6. The method of claim 1, wherein said key generation function includes computing the sum of at least two of said VLAN number, said SSID, and said mixer key.

7. The method of claim 1, wherein said key generation function includes a cryptographic function applied to at least two of said VLAN number, said SSID, and said mixer key.

8. The method of claim 7, wherein said cryptographic function is selected from the group consisting of MD5, SHA1, and AES.

9. A wireless switch of the type configured to receive a packet having a destination station within a virtual local area network (VLAN) having an associated VLAN number, said VLAN being mapped within a wireless local area network (WLAN) having an associated service set identification (SSID), said wireless switch comprising:
a key generation module configured to generate a key, wherein said key is produced by a key generation function applied to a broadcast key for said SSID, said VLAN number, and a mixer-key; and
an encryption module configured to encrypt said packet with said key to produce an encrypted packet.

10. The switch of claim 9, said key generation module further configured to generate said mixer key randomly when said SSID is initialized.

11. The switch of claim 10, said key generation module further configured to rotate a plurality of said broadcast keys and regenerate said mixer key during said rotating step.

12. The switch of claim 10, wherein key generation module is further configured to regenerate said mixer key when a mobile unit within said VLAN leaves said VLAN.

13. The switch of claim 9, wherein said mixer key is a null value.

14. The switch of claim 9, wherein said key generation module is configured to generate said key by adding at least two of said VLAN number, said SSID, and said mixer key.

15. The switch of claim 9, wherein said key generation module is configured to perform a cryptographic function on at least two of said VLAN number, said SSID, and said mixer key.

16. The method of claim 15, wherein said cryptographic function is selected from the group consisting of MD5, SHA1, and AES.
